(19) United States
(12) Patent Application Publication
(10) Pub. No.: US 2026/0316843 A1
(43) Pub. Date: Oct. 15, 2026

(54) VEHICLE FRONT PART STRUCTURE

(71) Applicant: Toyota Jidosha Kabushiki Kaisha, Toyota-shi (JP)

(72) Inventors: Takumi YASHIMA, Toyota-shi (JP); Hisashi JUFUKU, Seto-shi (JP)

(73) Assignee: Toyota Jidosha Kabushiki Kaisha, Toyota-shi (JP)

(21) Appl. No.: 19/535,453

(22) Filed: Feb. 10, 2026

(30) Foreign Application Priority Data
Apr. 11, 2025 (JP) 2025-065561

(51) Int. Cl. B62D 25/14

(52) U.S. Cl. CPC B62D 25/14

(57) ABSTRACT

The vehicle front part structure includes a dash panel separating a front compartment and a vehicle cabin, a high-voltage component provided on a surface of the dash panel on the front compartment side, a front side member provided on a vehicle front side and lower side than the high-voltage component than the dash panel and extending along the vehicle front-rear direction, a first connecting portion connected to the front side member, a second connecting portion connecting the dash panel and the high-voltage component, and a third connecting portion connecting the first connecting portion and the second connecting portion.

### CROSS-REFERENCE TO RELATED APPLICATION

This application claims priority to Japanese Patent Application No. 2025-065561 filed on Apr. 11, 2025. The disclosure of the above-identified application, including the specification, drawings, and claims, is incorporated by reference herein in its entirety.

### BACKGROUND

### 1. Technical Field

The present disclosure relates to a vehicle front part structure.

### 2. Description of Related Art

Japanese Unexamined Patent Application Publication No. 2020-069842 (JP 2020-069842 A) discloses a vehicle structure including an engine compartment provided in a front portion of a vehicle and in which a power plant including an engine, a transmission, and the like is disposed. The vehicle structure includes a pair of right and left front side members, a suspension member that suspends front wheels, and a dash panel that separates a vehicle cabin and the engine compartment.

### SUMMARY

In the vehicle structure described in JP 2020-069842 A, when an impact is input to the vehicle from the front side, the engine in the engine compartment moves toward the vehicle rear side. At this time, when a high-voltage component is provided on the rear side of the engine, there is a possibility that the engine collides with the high-voltage component from the front side, and the high-voltage component is pressed toward the rear side. When the high-voltage component is pressed toward the rear side, the high-voltage component moves toward the rear side. This may cause a situation in which the high-voltage component presses the dash panel toward the rear side (i.e., the vehicle cabin side).

In view of the above, it is an object of the present disclosure to provide a vehicle front part structure capable of improving safety by suppressing a situation in which a high-voltage component presses a dash panel toward a vehicle cabin side.

A first aspect provides a vehicle front part structure including:
a dash panel that separates a front compartment and a vehicle cabin;
a high-voltage component provided on a surface of the dash panel on a side of the front compartment;
a front side member provided in a vehicle front portion on a vehicle front side with respect to the dash panel and on a lower side with respect to the high-voltage component and extending along a vehicle front-rear direction;
a first connecting portion connected to the front side member;
a second connecting portion that connects the dash panel and the high-voltage component; and
a third connecting portion that connects the first connecting portion and the second connecting portion.

The vehicle front part structure according to the first aspect includes: a first connecting portion connected to the front side member; a second connecting portion that connects the dash panel and the high-voltage component; and a third connecting portion that connects the first connecting portion and the second connecting portion. When an impact is input to the vehicle from the front side, the front side member and the first connecting portion connected to the front side member are deformed. In the vehicle front part structure according to the first aspect, the front side member is provided on the lower side of the high-voltage component. Accordingly, when the front side member and the first connecting portion are deformed, the high-voltage component is pulled toward the vehicle lower side and moved toward the vehicle lower side via the second connecting portion and the third connecting portion.

On the other hand, when an impact is input to the vehicle from the front side, a device (such as an engine, for example; hereinafter referred to as a “front side device”) provided on the front side of the high-voltage component is provided is moved toward the rear side. In the vehicle front part structure according to the first aspect, as described above, when an impact is input to the vehicle from the front side, the high-voltage component moves to the vehicle lower side. Accordingly, when an impact is input to the vehicle from the front side, the high-voltage component moves under the front side device that moves toward the rear side. When the high-voltage component moves under the front side device, the high-voltage component is less likely to be pressed toward the rear side by the front side device. Therefore, it is possible to suppress a situation in which the high-voltage component pressed by the front side device presses the dash panel toward the rear side (that is, the vehicle cabin side). Therefore, the safety of the vehicle cabin can be improved.

A second aspect provides the vehicle front part structure according to the first aspect, in which the third connecting portion is connected to a lower portion of the second connecting portion.

In the vehicle front part structure according to the second aspect, the third connecting portion is connected to a lower portion of the second connecting portion. Thus, when an impact is input to the vehicle from the front side, the third connecting portion tends to pull the second connecting portion toward the lower side. Therefore, the high-voltage component can be more easily moved toward the lower side. Therefore, when an impact is input to the vehicle from the front side, the high-voltage component can be more easily moved under the front side device that moves toward the rear side.

As described above, the vehicle front part structure according to the present disclosure has an excellent effect of suppressing a situation in which a high-voltage component presses a dash panel toward the vehicle cabin side, and improving safety.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic longitudinal sectional view showing a main part of a vehicle front part structure according to an embodiment of the present disclosure; and

FIG. 2 is a perspective view showing a main part of a vehicle front part structure according to an embodiment of the present disclosure.

### DETAILED DESCRIPTION OF EMBODIMENTS

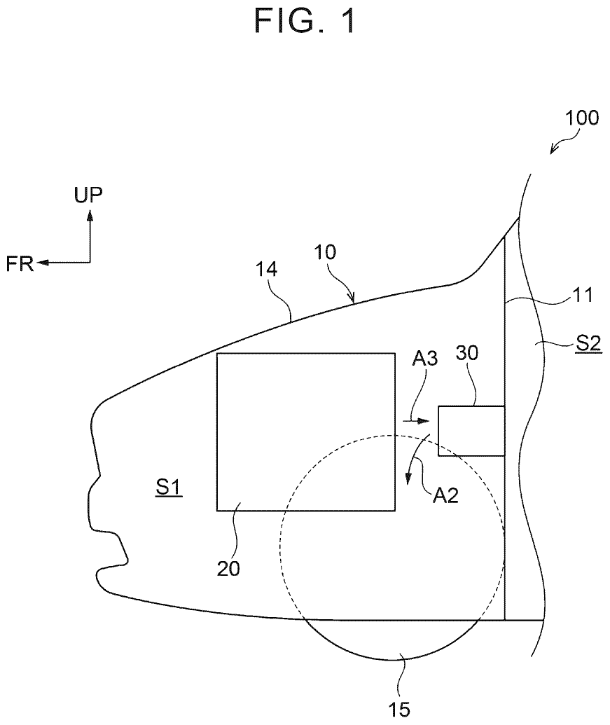

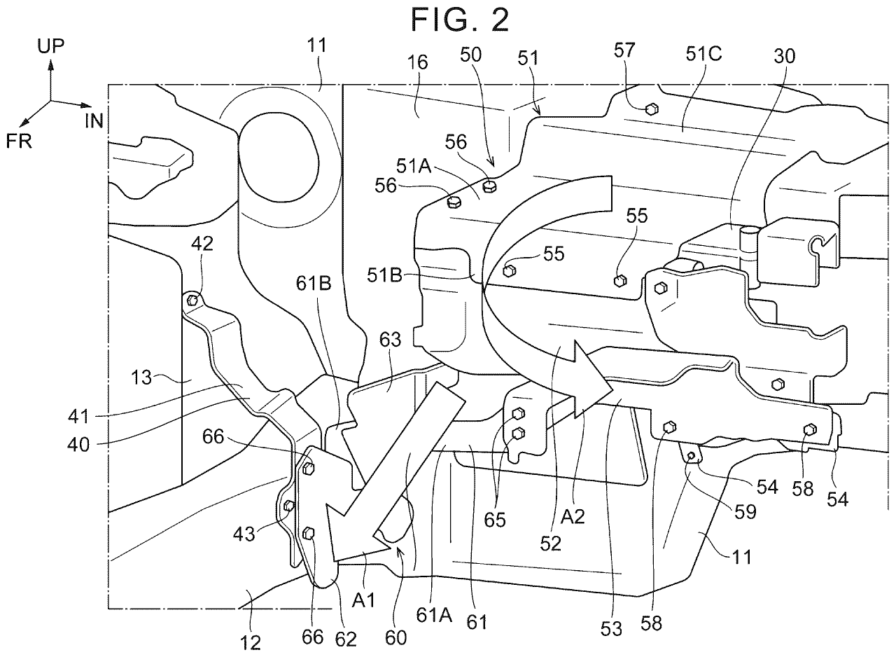

Hereinafter, an embodiment of a vehicle front part structure according to the present disclosure will be described with reference to FIGS. 1 and 2. Note that an arrow FR appropriately shown in the drawings indicates the front side of the vehicle in the vehicle front-rear direction, an arrow IN indicates the inner direction in the vehicle widthwise direction, and an arrow UP indicates the upper side of the vehicle in the vehicle up-down direction. In the following description, the terms “front-rear direction”, “width direction”, and “up-down direction” refer to the vehicle front-rear direction, the vehicle width direction, and the vehicle up-down direction, respectively. In addition, the left-right direction means a left-right direction in a state facing the front of the vehicle.

### A Vehicle, Comprising:

The vehicle 100 to which the vehicle front part structure according to the present embodiment is applied is, for example, a PHEV (Plug-in Hybrid Electric Vehicle) using an engine and a motor as a drive source. The vehicle 100 generates a driving force by burning fuel inside the engine. Further, the vehicle 100 travels by transmitting the driving force generated by the engine to the front wheels 15.

### Vehicle Front Part Structure

Next, the vehicle front part structure applied to the front portion of the vehicle 100 will be described with reference to FIGS. 1 and 2. FIG. 2 shows the inside of the front compartment S1.

As shown in FIGS. 1 and 2, the vehicle front part structure according to the present embodiment is adapted to the vehicle 100. As shown in FIG. 1, the vehicle front part structure includes a vehicle body 10 in which a front compartment S1 is provided at a front portion, and an engine 20 and a high-voltage component 30 provided in the front compartment S1. As shown in FIG. 2, the vehicle front part structure includes a first connecting portion 40, a second connecting portion 50, and a third connecting portion 60 that connect the vehicle body 10 and the high-voltage component 30.

As illustrated in FIGS. 1 and 2, the vehicle body 10 includes a dash panel 11 provided in front of the vehicle cabin S2 and separating the vehicle cabin S2 from the front compartment S1. The vehicle body 10 has a pair of right and left front side members 12 extending along the front-rear direction. The vehicle body 10 includes a pair of right and left suspension towers 13 provided outside the pair of front side members 12 in the vehicle width direction. The vehicle body 10 has a hood 14 that covers the front compartment S1 from above.

As shown in FIG. 1, a front compartment S1 is provided at a front portion of the vehicle body 10. The front compartment S1 is a space provided in front of the vehicle cabin S2, which is a space in which the occupant is seated, and is partitioned from the vehicle cabin S2 by a dash panel 11.

As shown in FIG. 1, the dash panel 11 is a plate-shaped member and is provided at a front portion of the vehicle 100. The front surface of the dash panel 11 faces the front compartment S1. The rear surface of the dash panel 11 faces the vehicle cabin S2. The high-voltage component 30 is attached to the front surface of the dash panel 11 by the second connecting portion 50. As shown in FIG. 2, an insulator 16 is attached to a front compartment S1 surface of the dash panel 11.

As shown in FIG. 2, the front side member 12 is provided on the vehicle front side of the dash panel 11. The front side member 12 is provided below the high-voltage component 30. The first connecting portion 40 is connected to the front side member 12.

The suspension tower 13 is provided on the front compartment S1. The suspension tower 13 is provided on the vehicle width direction outer side of the front side member 12. The suspension tower 13 is provided on the upper side of the front wheel 15 of the vehicle 100. The first connecting portion 40 is connected to the suspension tower 13.

As shown in FIG. 1, the engine 20 is provided in the front compartment S1. The engine 20 is provided on the front side of the high-voltage component 30 in the vehicle front-rear direction. The engine 20 and the high-voltage component 30 are separated from each other in the vehicle front-rear direction. The rear surface of the engine 20 and the front surface of the high-voltage component 30 face each other. The engine 20 is provided at a position overlapping with the high-voltage component 30 when viewed from the vehicle front-rear direction.

The high-voltage component 30 is attached to the front surface of the dash panel 11. Specifically, the high-voltage component 30 is attached to the front surface of the dash panel 11 by the second connecting portion 50. The high-voltage component 30 is provided at a position overlapping with the engine 20 when viewed from the vehicle front-rear direction. The high-voltage component 30 includes a housing that forms an outer shell, and a device through which high-voltage electricity is supplied to be housed inside the housing.

The high-voltage component 30 may be any device through which a current flows, and is not limited to a specific device. An exemplary high-voltage component is a device (LLC temperature control device) that regulates the temperature of LLC (Long Life Coolant) that cools the engine 20 with electric power.

As shown in FIG. 2, the first connecting portion 40 connects the front side member 12 and the suspension tower 13. The first connecting portion 40 has a side member connecting bracket 41 extending in the up-down direction. The side member connecting bracket 41 is curved and bent along the surfaces of the suspension tower 13 and the front side member 12.

The upper end portion of the side member connecting bracket 41 is in contact with the upper surface of the suspension tower 13. The upper end portion of the side member connecting bracket 41 is connected to the suspension tower 13 by a bolt 42.

Further, the lower end portion of the side member connecting bracket 41 is in contact with the inner surface of the front side member 12 in the vehicle width direction. A lower end portion of the side member connecting bracket 41 is connected to the front side member 12 by a bolt 43.

The second connecting portion 50 connects the dash panel 11 and the high-voltage component 30. In other words, the second connecting portion 50 attaches the high-voltage component 30 to the dash panel 11.

The second connecting portion 50 includes an upper side covering bracket 51 covering the upper portion of the high-voltage component 30, and a lower side covering bracket 52 covering the lower portion of the high-voltage component. The second connecting portion 50 includes a lower bracket 53 connected to the lower side covering bracket 52, and a mounting bracket 54 connected to the lower bracket 53.

The upper side covering bracket 51 covers the upper surface of the high-voltage component 30 and the upper portion of the front surface. The upper side covering brackets 51 integrally have a first portion 51A, a second portion 51B, and a third portion 51C. The first portion 51A extends along the upper surface of the high-voltage component 30. The second portion 51B is bent downward from the front end of the first portion 51A. The third portion 51C extends upward and rearward from the rear end of the first portion 51A.

The first portion 51A is a plate-shaped member covering the upper surface of the high-voltage component 30 from above. The first portion 51A is connected to the high-voltage component 30 by bolts 56 penetrating in the plate thickness direction (vertical direction).

The second portion 51B is a plate-like member covering the upper portion of the front surface of the high-voltage component 30 from the front side. The second portion 51B is connected to the lower side covering bracket 52 and the high-voltage component 30 by a plurality of bolts 55 penetrating in the plate thickness direction (front-rear direction).

The third portion 51C is a plate-shaped member that abuts the dash panel 11. The third portion 51C is connected to the front compartment S1 surface of the dash panel 11 by bolts 57 extending through the plate thickness.

The lower side covering bracket 52 is a plate-like member covering the lower surface of the high-voltage component 30 and the lower portion of the front surface. The upper end portion of the lower side covering bracket 52 is provided so as to overlap the second portion 51B of the upper side covering bracket 51 in the front-rear direction. An upper end portion of the lower side covering bracket 52 is sandwiched between the second portion 51B of the upper side covering bracket 51 and the high-voltage component 30. The upper end of the lower side covering bracket 52 is connected to the second portion 51B of the upper side covering bracket 51 and the high-voltage component 30 by means of bolts 55 passing through in the thickness direction. The lower end portion of the lower side covering bracket 52 is in contact with the lower bracket 53. The lower end portion of the lower side covering bracket 52 is connected to the lower bracket 53 by bolts (not shown).

The lower bracket 53 has an upper portion connected to the lower side covering bracket 52. Further, the lower bracket 53 has an inner end portion in the vehicle width direction connected to the L-shaped bracket 61 of the third connecting portion 60 by a bolt 65. Further, the lower end portion of the lower bracket 53 is connected to the mounting bracket 54 by a plurality of bolts 58 penetrating in the plate thickness direction.

The mounting brackets 54 are plate-shaped members that abut against the front compartment S1 surface. The lower bracket 53 is provided so as to overlap the lower end portion in the front-rear direction. The mounting bracket 54 is sandwiched between the lower bracket 53 and the front compartment S1 surface of the dash panel 11. The mounting bracket 54 is connected to the lower bracket 53 by a plurality of bolts 58 penetrating in the plate thickness direction. In addition, the mounting brackets 54 are connected to the front compartment S1 surface by bolts 59 extending through the plate thickness.

The third connecting portion 60 connects the first connecting portion 40 and the lower portion of the second connecting portion 50. Specifically, the third connecting portion 60 connects the lower end portion of the side member connecting bracket 41 of the first connecting portion 40 and the lower bracket 53 of the second connecting portion 50.

The third connecting portion 60 has an L-shaped bracket 61 connected to the lower bracket 53 of the second connecting portion 50. The third connecting portion 60 has a connecting bracket 62 connected to a lower end portion of the side member connecting bracket 41 of the first connecting portion 40. The third connecting portion 60 has a support bracket 63 fixed to the L-shaped bracket 61. The support bracket 63 supports a supported device (not shown).

The L-shaped bracket 61 integrally has a first portion 61A extending along the dash panel 11 and a second portion 61B bent from an outer end portion of the first portion 61A in the vehicle widthwise direction and extending toward the vehicle front side.

The first portion 61A extends linearly along the vehicle-width direction. The lower brackets 53 of the second connecting portions 50 are connected to one end (inner end) of the first portion 61A in the vehicle-width direction by bolts 65. The other end portion (outer end portion) of the first portion 61A is located on the rear side of the support brackets 63. The support brackets 63 are welded to the front surface of the other end (outer end) of the first portion 61A.

The second portion 61B is a plate-shaped member extending along the front-rear direction of the vehicle. The rear end of the second portion 61B is connected to the first portion 61A. The second portion 61B is provided on the vehicle-width-direction inner side of the front side member 12 and extends along the front side member 12. Connecting brackets 62 are welded to the vehicle-widthwise inner surface of the second portion 61B.

The connecting bracket 62 is a plate-shaped member. The rear end portion of the connecting bracket 62 abuts on the second portion 61B of the L-shaped bracket 61 from the vehicle-width-direction inner side. The rear end portion of the connecting brackets 62 is welded to the vehicle-width-direction inner surface of the second portion 61B. The front end portion of the connecting bracket 62 is in contact with the side member connecting bracket 41 of the first connecting portion 40 from the inside in the vehicle width direction. The front end portion of the connecting bracket 62 is connected to the side member connecting bracket 41 by a plurality of bolts 66 penetrating in the plate thickness direction.

### Action and Effect

According to the present embodiment, the following effects can be obtained. As shown in FIG. 2, in the present embodiment, the vehicle front part structure includes a first connecting portion 40 connected to the front side member 12. The vehicle front part structure includes a second connecting portion 50 that connects the dash panel 11 and the high-voltage component 30. The vehicle front part structure includes a third connecting portion 60 that connects the first connecting portion 40 and the second connecting portion 50. When an impact is input to the vehicle 100 from the front side, the first connecting portion 40 connected to the front side member 12 and the front side member 12 is deformed. In the present embodiment, the front side member 12 is provided on the lower side of the high-voltage component 30. As a result, the front side member 12 and the first connecting portion 40 are deformed, so that the high-voltage component 30 is pulled downward through the second connecting portion 50 and the third connecting portion 60 (see the arrow A1 in FIG. 2). As a result, the high-voltage component 30 moves toward the lower side of the vehicle such that the front end rotates downward around the rear end (see the arrow A2 in FIGS. 1 and 2).

Specifically, when an impact is input to the vehicle 100 from the front side, the front side member 12 and the suspension tower 13 are deformed so as to be crushed while moving to the rear side. The front side member 12 has a structure that is more easily deformed than the suspension tower 13. Therefore, when the front side member 12 and the suspension tower 13 are deformed, the front side member 12 is deformed earlier than the suspension tower 13. Therefore, the rear end portion of the side member connecting bracket 41, which is connected to the front side member 12, moves to the rear side earlier than the upper end portion, which is connected to the suspension tower 13. The side member connecting bracket 41 connects the front side member 12 and the suspension tower 13. That is, the side member connecting bracket 41 has such a behavior as to rotate about the upper end portion. As a result, the connecting bracket 62 fixed to the rear end portion of the side member connecting bracket 41 also rotates while moving rearward. Specifically, the connecting bracket 62 moves to rotate counterclockwise when viewed from the inside in the vehicle width direction while moving to the rear side. As the connecting bracket 62 moves and rotates, the L-shaped bracket 61 fixed to the connecting bracket 62 and the second connecting portion 50 fixed to the L-shaped bracket 61 are drawn downward. In this way, the high-voltage component 30 is pulled downward (see the arrow A1 in FIG. 2). As a result, the high-voltage component 30 moves toward the lower side of the vehicle such that the front end rotates downward around the rear end (see the arrow A2 in FIGS. 1 and 2).

On the other hand, when an impact is inputted to the vehicle 100 from the front side, the engine 20 provided on the front side of the high-voltage component 30 moves to the rear side (see the arrow A3 in FIG. 1). In the present embodiment, as described above, when an impact is input to the vehicle 100 from the front side, the high-voltage component 30 moves to the vehicle lower side. Accordingly, when an impact is input to the vehicle 100 from the front side, the high-voltage component 30 is submerged under the engine 20 moving to the rear side. When the high-voltage component 30 moves so as to submerge under the engine 20, the high-voltage component 30 is less likely to be pushed backward by the engine 20. Therefore, it is possible to suppress a situation in which the high-voltage component 30 pressed by the engine 20 presses the dash panel 11 toward the rear side (that is, the vehicle cabin side). Therefore, the vehicle cabin S2 and the passenger safety can be improved.

Further, in the present embodiment, as described above, when an impact is input to the vehicle 100 from the front side, the high-voltage component 30 moves so as to be submerged under the engine 20. This makes it difficult for the high-voltage component 30 to be pushed backward by the engine 20. Therefore, damage to the high-voltage component 30 can be suppressed.

Further, in the present embodiment, as described above, when an impact is input to the vehicle 100 from the front side, the high-voltage component 30 moves so as to be submerged under the engine 20. As a result, the high-voltage component 30 is covered from the upper side by the engine 20. Therefore, the exposure of the high-voltage component 30 is reduced. Therefore, for example, it is difficult for an occupant, an operator, or the like to access the high-voltage component 30, and thus safety can be improved.

When an impact is input to the vehicle 100 from the front side, the high-voltage component 30 does not infiltrate under the engine 20. In other words, in order to ensure the travel distance (stroke) of the engine 20 in the vehicle front-rear direction during a vehicle collision, the distance between the engine 20 and the high-voltage component 30 needs to be relatively long. On the other hand, in the present embodiment, as described above, when an impact is input to the vehicle 100 from the front side, the high-voltage component 30 moves so as to be submerged under the engine 20. Accordingly, the moving distance of the engine 20 at the time of collision can be increased. Therefore, the distance between the engine 20 and the high-voltage component 30 can be relatively short. Therefore, the length of the vehicle 100 in the front-rear direction can be shortened. Alternatively, the volume of the vehicle cabin S2 can be increased.

In the present embodiment, the third connecting portion 60 is connected to the lower portion of the second connecting portion 50. Thus, when an impact is input to the vehicle 100 from the front side, the third connecting portion 60 easily pulls the second connecting portion 50 downward. Therefore, the high-voltage component 30 can be more easily moved downward. Therefore, in a case where an impact is input to the vehicle 100 from the front side, the high-voltage component 30 can be more preferably easily submerged under the engine 20 moving to the rear side.

Although the vehicle front part structure according to the embodiment has been described above, the present disclosure can be appropriately changed in design without departing from the gist thereof.

For example, in the above embodiment, the second connecting portion 50 has been described as an example having a plurality of (in the present embodiment, four) members (specifically, brackets), but the present disclosure is not limited thereto. The second connecting portion 50 may be configured by a single member or a plurality of members other than 4, as long as the high-voltage component 30 and the dash panel 11 can be connected to each other.

Further, in the above embodiment, the third connecting portion 60 has been described an example having a plurality of (three in the present embodiment) members (specifically, brackets), the present disclosure is not limited thereto. The third connecting portion 60 may be configured to connect the first connecting portion 40 and the second connecting portion 50, may be configured by a single member, or may be configured by a plurality of members other than three.

Further, the number of bolts connecting the respective members is arbitrary, and is not limited to the number described above.

What is claimed is:

1. A vehicle front part structure comprising:
a dash panel that separates a front compartment and a vehicle cabin;
a high-voltage component provided on a surface of the dash panel on a side of the front compartment;
a front side member provided in a vehicle front portion on a vehicle front side with respect to the dash panel and on a lower side with respect to the high-voltage component and extending along a vehicle front-rear direction;
a first connecting portion connected to the front side member;
a second connecting portion that connects the dash panel and the high-voltage component; and
a third connecting portion that connects the first connecting portion and the second connecting portion.

2. The vehicle front part structure according to claim 1, wherein the third connecting portion is connected to a lower portion of the second connecting portion.
